(19) United States
(12) Patent Application Publication
(10) Pub. No.: US 2004/0122768 A1
(43) Pub. Date: Jun. 24, 2004

(54) Electronic wallet for wireless computing device

(75) Inventors: Thomas E. Creamer, Boca Raton, FL (US); Victor S. Moore, Boynton Beach, FL (US); Wendi L. Nusbickel, Boca Raton, FL (US); Scott L. Winters, Austin, TX (US)

Correspondence Address: Gregory A. Nelson, Akerman Senterfitt, 222 Lakeview Avenue, Fourth Floor, P.O. Box 3188, West Palm Beach, FL, 33402-3188, US

(73) Assignee: International Business Machines Corporation, Armonk, NY

(21) Appl. No.: 10/324,439

(22) Filed: Dec. 19, 2002

(51) Int. Cl. G06F 17/60

(52) U.S. Cl. 705/41

(57) ABSTRACT

Using a wireless computing device, a method of conducting commerce can include storing a secure code and an associated balance amount within an electronic wallet application executing within the wireless computing device. The secure code can specify a financial institution and an account managed by the financial institution. The method further can include receiving within the electronic computing device an amount of a potential transaction and a personal identification code from a user, correlating the personal identification code with the secure code, and providing the personal identification code, the amount of the potential transaction, and the secure code to a merchant transaction processing system. The amount of the potential transaction can be deducted from the balance amount stored within the electronic wallet.

### BACKGROUND OF THE INVENTION

1. Technical Field

The invention relates to the field of wireless computing devices and, more particularly, to using a wireless computing device to perform financial transactions.

2. Description of the Related Art

Electronic wallets allow consumers to more easily conduct commerce over computer networks such as the Internet and/or the Web. Typically, an electronic wallet is an organized association of account numbers, passwords, and user information which can be automatically inserted into appropriate fields of a browser rendered markup language document. Such electronic wallet applications provide limited functionality which typically is constrained to “filling in” data for a user in an effort to spare the user from having to repeatedly enter the same personal information each time the user makes an online purchase.

Electronic wallets also have been implemented using standalone computing devices having display screens. Conventional electronic wallet devices can be programmed to present bar codes upon the display screen of the device. These conventional electronic wallet devices can be programmed to store and display any of several different bar codes which correspond to identification cards the user typically carries on his or her person. Because the electronic wallet device can display a given bar code responsive to a user request, the user need not carry the various individual cards if the bar code from the card is stored within the electronic wallet.

Standalone electronic wallet devices of the variety described above, however, typically do not incorporate any significant intelligence. That is, such devices merely store preprogrammed or static bar codes. The user can select an account, for example at the point of sale. Accordingly, the electronic wallet device can recall the bar code associated with the user selected account and present the bar code upon the display screen of the device. A bar code reader can then read account information represented by the bar code.

### SUMMARY OF THE INVENTION

The present invention provides a method and apparatus for conducting transactions using a wireless computing device. More particularly, the present invention provides an electronic wallet which can be implemented as an application program within a wireless computing device. The electronic wallet provides users with the ability to communicate with institutions through the wireless computing device and fund the electronic wallet account. The electronic wallet application can be accessed later by a user of the wireless device at a point of sale. Details of the financial transaction such as the account to be billed and the financial institution or transaction approval authority can be provided to merchant transaction processing equipment at the point of sale through one of several different methods.

For example, according to one embodiment of the present invention, the wireless computing device can transmit details of a proposed or potential financial transaction to the merchant transaction processing equipment via a short range wireless communications link. The merchant transaction processing system can then verify or authorize the transaction with the financial institution specified in the received wireless communication. Notably, such an embodiment allows the merchant transaction processing system to provide feedback to the wireless computing device as well.

In another embodiment, the wireless computing device can represent relevant transaction information as a graphic image. The graphic image can be generated by the electronic wallet application and can be presented upon a display screen of the wireless computing device. Accordingly, the merchant transaction processing system can receive pertinent details of the potential financial transaction by scanning the display screen of the wireless computing device using a bar coder reader.

One aspect of the present invention can include a method of conducting commerce using a wireless computing device. The method can include storing a secure code and an associated balance amount within an electronic wallet application executing within the wireless computing device. The secure code can specify a financial institution and an account managed by the financial institution. For example, a wireless communications link such as a wireless data communications link or a call over a wireless telephony link can be established with the financial institution. Over the established wireless communications link, a request for funding can be sent from the wireless computing device. The request can be for the balance amount and can be deducted from the specified account. The secure code can be received from the financial institution over the established communications link.

Within the wireless computing device, an amount of a potential transaction and a personal identification code can be received from a user. The personal identification code can be correlated with the secure code. The personal identification code, the amount of the potential transaction, and the secure code can be provided to a merchant transaction processing system.

According to one embodiment of the present invention, the step of providing information to the merchant transaction processing system can include dynamically representing the personal identification code, the amount of the potential transaction, and the secure code as a graphic image and presenting the graphic image upon a display of the wireless computing device. Thus, the merchant transaction processing system can read the graphic image, for example using a bar code reader linked to the merchant transaction processing system.

In another embodiment, the providing step can include establishing a short range wireless communications link with the merchant transaction processing system and sending the personal identification code, the amount of the potential transaction, and the secure code over the short range wireless communications link. In this embodiment, a transmission from the merchant transaction processing system can be received via the short range wireless communications link indicating the status of the potential transaction. Accordingly, a notification can be generated by the wireless computing device indicating the status of the potential transaction.

In any case, whether or not a response is received from the merchant transaction processing system, the amount of the potential transaction can be deducted from the balance amount stored within the electronic wallet application. The secure code can be modified by the electronic wallet application after each transaction using a predetermined protocol or algorithm such that the secure code changes on a per transaction basis.

### BRIEF DESCRIPTION OF THE DRAWINGS

There are shown in the drawings embodiments which are presently preferred, it being understood, however, that the invention is not limited to the precise arrangements and instrumentalities shown.

FIG. 1 is a flow chart illustrating a method of funding an electronic wallet account in accordance with the present invention.

FIG. 2 is a flow chart illustrating a method of conducting financial transactions using a wireless computing device in accordance with the present invention.

FIG. 3 is a flow chart illustrating another method of conducting financial transactions using a wireless computing device in accordance with the present invention.

### DETAILED DESCRIPTION OF THE INVENTION

The present invention provides a method and apparatus for conducting financial transactions using a wireless computing device. More particularly, the present invention provides an electronic wallet which can be implemented as an application program executing within a wireless computing device. The electronic wallet application provides users with the ability to communicate with financial institutions through the wireless computing device to fund the electronic wallet application. The term “financial institution” as used herein can include a bank or other entity which is charged with maintaining an account, whether a debit or credit account, making advances against the account, as well as providing authorization for transactions to be billed against the account.

Once funded, the electronic wallet application can be accessed by a user of the wireless device at a point of sale. Details of the financial transaction such as the account to be billed and the financial institution or transaction approval authority can be provided to merchant transaction processing equipment at the point of sale through one of several different methods including a short range wireless communications link or by displaying a suitable graphic coding system such as a bar code upon the display screen of the wireless computing device.

The term “bar code” as used herein, can include any of a variety of graphic symbols or visual images. The bar code can be formed from an ordering of spaced vertical bars, wherein both the thickness of the bars and the amount of space between the bars can vary. The arrangement of bars and spacing specifies encoded information. For example, the bar code can be a conventional low, medium, or high density bar code. The bar code, however, also can be a single dimension, dual dimension and/or multidimensional bar code. Still, the bar code need not be formed of bars and spaces at all, but rather any image which can be read or interpreted using a scanning device capable of detecting visually detectable patterns, referred to as a “bar code” reader or scanner. Although a variety of existing bar code encoding standards exist, a bar code can specify information, whether numbers, characters, and/or symbols, using any protocol which both the bar code reader, and decoder if separate from the bar code reader, and the bar code generating device have been configured or programmed to implement.

The present invention can be implemented using a portable, wireless computing device (wireless device) such as a personal digital assistant, a laptop computer, a wireless or cellular telephone, and the like. The wireless device can be configured to conduct long range wireless communications such as establishing wireless or cellular telephone calls or accessing the Internet, the Web, or another computing network via a wireless data communications link.

The wireless device can be configured to execute applications such as the electronic wallet application. Accordingly, the wireless device can provide an execution environment for executing any of a variety of different applications, whether browser-based applications or self-contained applications which do not require a virtual machine for execution. For example, according to one embodiment of the present invention, the wireless device can include an execution environment which supports the execution of client applications created in conformance with the Java™ 2 Enterprise Edition (J2EE) platform.

In one aspect of the present invention, the wireless device can include a display screen such as a liquid crystal display (LCD) screen or any other display screen upon which bar codes can be presented which can be read by bar code readers. In another aspect, the wireless device, although enabled to conduct long range wireless communications, can include a transceiver for conducting short range wireless communications. For example, the wireless device can be Bluetooth enabled or include hardware and software support for implementing one of the 802.11 family of wireless communications protocols.

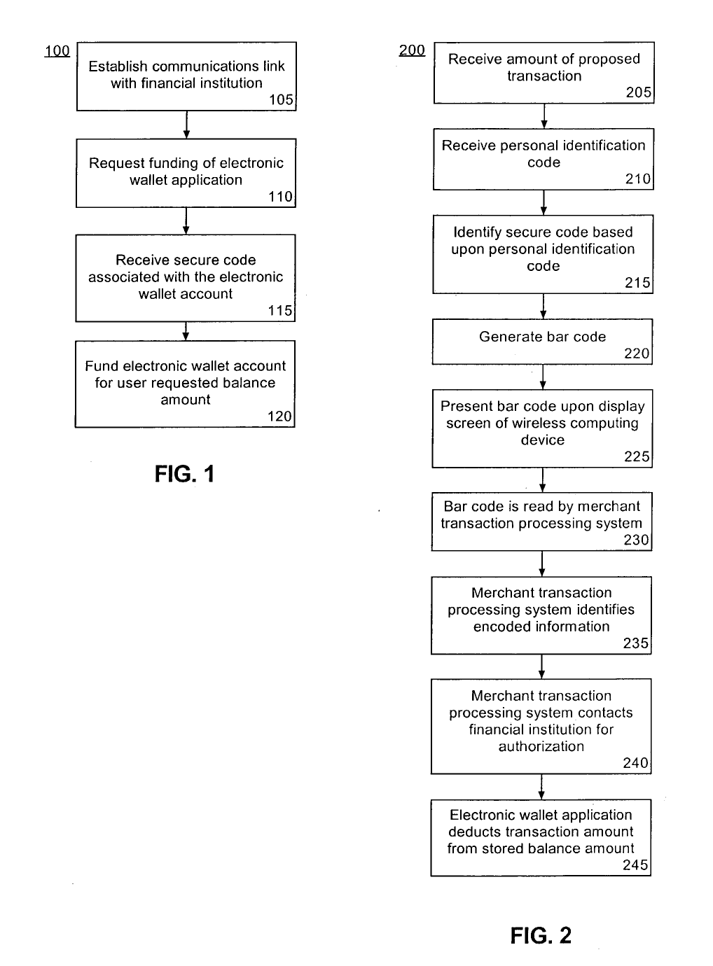

FIG. 1 is a flow chart illustrating a method 100 of funding an electronic wallet in accordance with the present invention. The method 100 can be performed using a wireless device as previously described. As mentioned, the wireless device can include an electronic wallet application which can control various functions of the wireless device including initiating and establishing calls, sending long and short range wireless communications, as well as generating bar codes and rendering the bar codes upon the display screen of the wireless device. The electronic wallet application also can increment, decrement, and maintain a stored balance responsive to communications with a user, merchant equipment, and/or authorized financial institutions.

The method 100 can begin in step 105, where a user can command the wireless device to establish a communications link with a financial institution. For example, the user can launch the electronic wallet application within the wireless device and provide the appropriate user command to initiate communications with the financial institution. Such a user command can be a key command, a pointer command, and/or a voice command in the case where the wireless device is voice-enabled. Alternatively, the electronic wallet application can execute as a background process such that the user need only provide a command to wake up the electronic wallet application and initiate communications.

Accordingly, the user input or command can specify a particular financial institution to be contacted, an account which is maintained by the selected financial institution, as well as an amount in which the electronic wallet is to be funded. For example, in one embodiment, the user can select a financial institution from a user specific financial profile stored within the electronic wallet application. The financial profile can list financial institutions which can be accessed and used to fund the electronic wallet application. The contact information for each financial institution also can be specified within the user specific financial profile as well as the means by which the financial institution is to be contacted for electronic wallet funding requests. Still, the user can manually specify the financial institution contact information as well as the manner in which the financial institution is to be contacted as needed.

Thus, depending upon the particular capabilities of the wireless device, the financial institution, as well as contact information within the financial profile, the wireless device can place a telephone call to the financial institution or establish a wireless data communications link with the financial institution. For example, the wireless device can dial a telephone number for the financial institution and send data over an audio channel using a modem or can access a network address corresponding to the financial institution over a wireless data communications link. Data can be sent over the wireless data communications link using Wireless Application Protocol (WAP), Short Message Service (SMS), or another suitable communications protocol for wireless data communications.

In step 110, once a communications link is established between the wireless device and the financial institution, the electronic wallet application can request funding from the financial institution. The request can specify the user designated account which will be used to fund the electronic wallet application. Notably, the request also can include information which can be used to authenticate and verify the identity of the user. For example, the user can be required to enter a password or provide biometric information through an appropriate interface of the wireless device which can be sent to the financial institution for added security.

Having received the request for funding from the electronic wallet application, the financial institution can process the request. That is the financial institution can verify user identity, account balances, as well as any other parameters prior to funding the requesting electronic wallet application from the user designated account. If the financial institution determines that the electronic wallet application is to be funded, the information processing systems of the financial institution can generate a secure code which can be associated with the user's electronic wallet account. This information can be stored within the information processing systems of the financial institution for later use.

Accordingly, in step 115, the electronic wallet can receive the secure code, whether over an established wireless telephone call or the wireless data communications link. The secure code can specify, either directly or indirectly, the financial institution which funded the electronic wallet and the particular user account from which funds were extracted to fund the electronic wallet. The electronic wallet also can receive a number indicating the account balance of the electronic wallet. Notably, this number can be specified by the secure code or can be provided as a separate number. In any case, the secure code can be associated with the electronic wallet, and therefore, the user of the electronic wallet. In step 120, the electronic wallet application can process the received secure code and update the account balance information stored therein to reflect the correct balance amount received from the financial institution.

FIG. 2 is a flow chart illustrating a method 200 of conducting financial transactions using a wireless computing device in accordance with the present invention. The method 200 can begin in state wherein the electronic wallet application is executing. Accordingly, in step 205, the wireless device can receive a user input specifying an amount of a purchase or potential transaction. The user can specify the amount of the potential transaction either responsive to a prompt from the electronic application or by initiating the transaction without such a prompt. Depending upon the particular functionality of the wireless device and the electronic wallet application, the user can specify the amount using key commands, pointer actions, and/or voice commands.

In step 210, the wireless device can receive a personal identification code corresponding to the requesting user. The personal identification code can be specified as a voice input or command, for example a voice print or other biometric information if the wireless device is so equipped, a key code, and/or a pointer command. In step 215, the electronic wallet application can match the received personal identification code to the secure code previously downloaded or received from the financial institution. By associating personal identification codes with secure codes, it is within the scope of the present invention to utilize the same electronic wallet application and wireless device for more than one user wherein each user can be associated with a different secure code, and therefore, his or her own financial institution, account, and available balance for conducting transactions.

In step 220, the electronic wallet can generate a bar code. More particularly, the electronic wallet, using a predetermined bar code encoding protocol, can generate a bar code which specifies the amount of the potential transaction, the user's personal identification code, and the secure code obtained from the financial institution. In step 225, the generated bar code can be presented upon the display of the wireless device. Accordingly, the user of the wireless device can present the device within the range of a bar code reader which can be incorporated into a merchant transaction processing system at a point of sale.

In step 230, the bar code can be read by the merchant transaction processing system. In step 235, the merchant transaction processing system can identify encoded information from the bar code. The merchant transaction processing system can be programmed to decode the bar code to determine the potential transaction amount, the user's personal identification code, and the secure code. In one embodiment, the merchant transaction processing system need not decode the entire bar code. For example, the merchant transaction processing system can be configured to partially decode the bar code so as to only determine enough information to identify the financial institution, the account linked to the electronic wallet, and the transaction amount. That is, the merchant transaction processing system can be programmatically constrained from fully decoding the bar code and can instead decode only information which may be required by the financial institution to authorize the transaction.

It should be appreciated that the merchant transaction processing system, no matter how much information is determined from the bar code, need not display any user specific information to an operator. Thus, the user's personal financial information, including actual account numbers, can remain confidential.

In step 240, the merchant transaction processing system can contact the financial institution to obtain authorization to complete the transaction. The merchant transaction processing system can send the user's personal identification code, the account to be accessed, as well as the amount of the potential transaction to the financial institution. The merchant transaction processing system can determine the contact information for the financial institution from either a profile stored on the merchant system or from the bar code itself. The merchant transaction processing system can contact the financial institution through a suitable communications channel, whether wireless or a wired connection.

The financial institution can verify the received data and grant authorization to the merchant transaction processing system. The merchant transaction processing system can then complete the transaction. In step 245, the transaction amount can be deducted from the available balance of the electronic wallet. The secure code can be modified by the electronic wallet application after each transaction using a predetermined protocol or algorithm such that the secure code changes on a per transaction basis or after a predetermined number of transactions. Accordingly, the electronic wallet application and the information processing systems of the financial institution can remain synchronized in that each can modify the secure code used by the electronic wallet application in the same manner. Thus, the secure code can change on a per transaction basis if desired for added security.

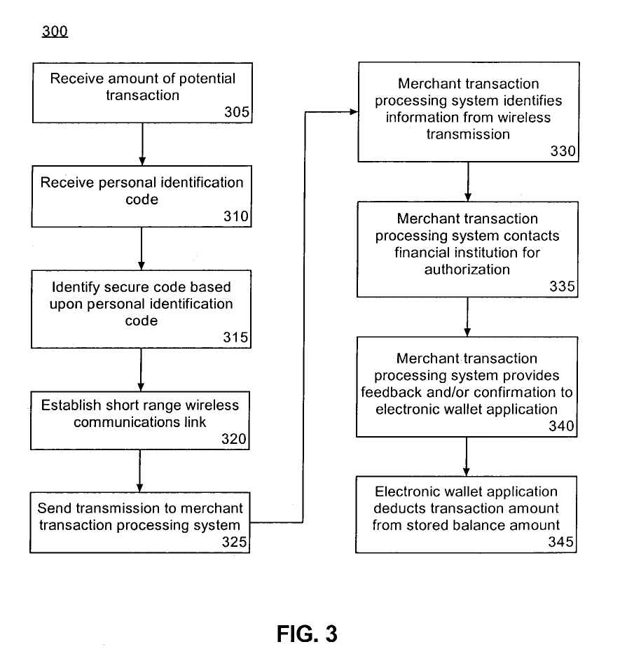

FIG. 3 is a flow chart illustrating another method 300 of conducting financial transactions using a wireless computing device in accordance with the present invention. The method 300 is similar to the method described with reference to FIG. 2, with the exception that short range wireless communications are utilized to communicate with the merchant transaction processing system rather than bar codes. The method can begin in step 305 where the wireless device can receive a user input specifying an amount of a potential transaction. In step 310, the wireless device can receive a user specified personal identification code.

In step 315, using the user provided personal identification code, the electronic wallet application can identify the secure code previously obtained from the financial institution. In step 320, the wireless device can establish a short range wireless communications link with the merchant transaction processing system. As noted, the secure code can specify the financial institution which manages the account associated with the electronic wallet application as well as the account. Thus, in step 325, the wireless device can send a transmission to the merchant transaction processing system via the short range wireless communications link. The transmission can specify the user's personal identification code, the transaction amount, as well as the secure code.

As described with reference to FIG. 2, in step 330, the merchant transaction processing system can determine any relevant or needed information from the received wireless transmission such as the financial institution, the user's personal identification code, and the account to be accessed. As noted, the merchant transaction processing system can be constrained from fully identifying user information.

Accordingly, in step 335, the merchant transaction processing system can contact the financial institution to obtain authorization in order to complete the transaction. In step 340, the merchant transaction processing system can provide feedback to the wireless device, and therefore the electronic wallet application, indicating whether the transaction was approved. In step 345, the electronic wallet application can deduct the transaction amount from the user's electronic wallet account balance in the event that the merchant transaction processing system indicates that the transaction was approved.

In this embodiment of the present invention, as the short range wireless communications link supports two-way communications, the merchant transaction processing system can provide feedback to the wireless computing device. Accordingly, the electronic wallet application can ensure that the transaction was approved prior to deducting the transaction amount from the user's available balance. Similar to the previous embodiment, the secure code can be modified on a per transaction basis.

The present invention can be realized in hardware, software, or a combination of hardware and software. The present invention can be realized in a centralized fashion in one computer system, or in a distributed fashion where different elements are spread across several interconnected computer systems. Any kind of computer system or other apparatus adapted for carrying out the methods described herein is suited. A typical combination of hardware and software can be a general purpose computer system with a computer program that, when being loaded and executed, controls the computer system such that it carries out the methods described herein.

The present invention also can be embedded in a computer program product, which comprises all the features enabling the implementation of the methods described herein, and which when loaded in a computer system is able to carry out these methods. Computer program or application in the present context means any expression, in any language, code or notation, of a set of instructions intended to cause a system having an information processing capability to perform a particular function either directly or after either or both of the following: a) conversion to another language, code or notation; b) reproduction in a different material form.

This invention can be embodied in other forms without departing from the spirit or essential attributes thereof. Accordingly, reference should be made to the following claims, rather than to the foregoing specification, as indicating the scope of the invention.

What is claimed is:

1. Using a wireless computing device, a method of conducting commerce comprising:
storing a secure code and an associated balance amount within an electronic wallet application executing within the wireless computing device, wherein the secure code specifies a financial institution and an account managed by the financial institution;
within the wireless computing device, receiving from a user an amount of a potential transaction and a personal identification code;
correlating the personal identification code with the secure code;
providing the personal identification code, the amount of the potential transaction, and the secure code to a merchant transaction processing system; and
deducting the amount of the potential transaction from the balance amount stored within the electronic wallet.

2. The method of claim 1, said storing step further comprising:
establishing a wireless communications link with the financial institution;
requesting funding of the electronic wallet for the balance amount to be deducted from the account; and
receiving the secure code from the financial institution.

3. The method of claim 2, said step of establishing a wireless communications link comprising:
establishing a wireless data communications link with the financial institution, wherein said requesting and receiving steps are performed using the wireless data communications link.

4. The method of claim 2, said step of establishing a wireless communications link comprising:
calling the financial institution over a wireless telephony link, wherein said requesting and receiving steps are performed using the wireless telephony link.

5. The method of claim 1, said providing step further comprising:
dynamically representing the personal identification code, the amount of the potential transaction, and the secure code as a graphic image; and
presenting the graphic image upon a display of the wireless computing device, such that the merchant transaction processing system can read the graphic image.

6. The method of claim 1, said providing step further comprising:
establishing a short range wireless communications link with the merchant transaction processing system; and
sending the personal identification code, the amount of the potential transaction, and the secure code over the short range wireless communications link.

7. The method of claim 6, further comprising:
receiving a transmission from the merchant transaction processing system via the short range wireless communications link indicating the status of the proposed transaction.

8. The method of claim 1, further comprising:
modifying the secure code using a predetermined modification scheme after each transaction.

9. A machine readable storage, having stored thereon a computer program having a plurality of code sections executable by a machine for causing the machine to perform the steps of:
storing a secure code and an associated balance amount within an electronic wallet application executing within a wireless computing device, wherein the secure code specifies a financial institution and an account managed by the financial institution;
within the wireless computing device, receiving from a user an amount of a potential transaction and a personal identification code;
correlating the personal identification code with the secure code;
providing the personal identification code, the amount of the potential transaction, and the secure code to a merchant transaction processing system; and
deducting the amount of the potential transaction from the balance amount stored within the electronic wallet.

10. The machine readable storage of claim 9, said storing step further comprising:
establishing a communications link with the financial institution;
requesting funding of the electronic wallet for the balance amount to be deducted from the account; and
receiving the secure code from the financial institution.

11. The machine readable storage of claim 10, said step of establishing a communications link comprising:
establishing a wireless data communications link with the financial institution, wherein said requesting and receiving steps are performed using the wireless data communications link.

12. The machine readable storage of claim 10, said step of establishing a communications link comprising:
calling the financial institution over a wireless telephony link, wherein said requesting and receiving steps are performed using the wireless telephony link.

13. The machine readable storage of claim 9, said providing step further comprising:
dynamically representing the personal identification code, the amount of the potential transaction, and the secure code as a graphic image; and
presenting the graphic image upon a display of the wireless computing device, such that the merchant transaction processing system can read the graphic image.

14. The machine readable storage of claim 9, said providing step further comprising:
establishing a short range wireless communications link with the merchant transaction processing system; and
sending the personal identification code, the amount of the potential transaction, and the secure code over the short range wireless communications link.

15. The machine readable storage of claim 14, further comprising:
receiving a transmission from the merchant transaction processing system via the short range wireless communications link indicating the status of the proposed transaction.

16. The machine readable storage of claim 9, further comprising:
modifying the secure code using a predetermined modification scheme after each transaction.
